(19) United States
(12) Patent Application Publication
(10) Pub. No.: US 2011/0215532 A1
(43) Pub. Date: Sep. 8, 2011

(54) FERROFLUID SEALING APPARATUS FOR A RECIPROCATING SHAFT

(75) Inventors: Decai Li, Beijing (CN); Wenming Yang, Beijing (CN)

(73) Assignee: Beijing Jiaotong University

(21) Appl. No.: 13/040,303

(22) Filed: Mar. 4, 2011

(30) Foreign Application Priority Data
Mar. 8, 2010 (CN) 201010120466.7

(51) Int. Cl. F16J 15/43

(52) U.S. Cl. 277/410

(57) ABSTRACT

A ferrofluid sealing apparatus for a reciprocating shaft, in which the first bearing, the first magnetism isolating rings, the first pole piece, the first O-shaped rubber seal, a magnet, the second O-shaped rubber seal, the second pole piece, the second magnetism isolating ring, and the second bearing are sandwiched between the two inner bosses of the outer casing in series, an end cover is fixed on the outer casing by means of screws so that the second bearing is pressed, there are provided with three step holes in the inner torus of the second (13) pole piece as the left step hole, the middle step hole, and the right step hole, in which N+1 of elastic rings (T) and trapezoidal teeth (C) are arranged closely with interval of the middle step hole, where N is a positive integer in 1 to 8, the teeth and rings are connected with the second pole piece by means of screws and shield rings (15), the N of trapezoidal teeth (C) are arranged with the same expanding direction of their inner holes, the first pole piece has the same structure with the second pole piece. The invention can overcome the problems of loss of ferrofluid, decrease of the sealing life, and increase of the leakage rate.

### FIELD OF THE PRESENT INVENTION

The invention is related to the sealing technology field in mechanical engineering, especially a seal of a reciprocating shaft.

### BACKGROUND OF THE PRESENT INVENTION

In the present ferrofluid sealing technology for the reciprocating shaft, the ferrofluid in the sealing gaps is made to distort when the shaft moves in a speed and a stroke, and the ferrofluid under each teeth is carried to the teeth at the front end in the moving direction. Such that when the excess ferrofluid cannot be restrained by the magnetic field under the teeth in front end, an amount of ferrofluid will loss, which will result in a reduction of the sealing life, a descending of the pressure capability or pressure endurance capability, and an increase of the leakage of the sealed medium.

### SUMMARY OF THE PRESENT INVENTION

The object of the present invention is to provide a ferrofluid sealing apparatus for a reciprocating shaft, so as to avoid the loss of ferrofluid, the decreasing of sealing life and pressure endurance capability, and the increase of the leakage of the sealed medium if using the present ferrofluid seals.

The technical solution of the present invention is as follows.

There is provided a ferrofluid sealing apparatus for a reciprocating shaft. The first bearing, the first magnetism isolating rings, the first pole piece, the first O-shaped rubber seal, a magnet, the second O-shaped rubber seal, the second pole piece, the second magnetism isolating ring, and the second bearing are sandwiched between the two inner bosses of the outer casing in series. The end cover is fixed on the outer casing by means of screws so that the second bearing is pressed. The ferrofluid is injected into the inner torus of the magnet during operation. The above sealing structure is installed to the reciprocating shaft plated with polytetrafluoroethylene.

There are provided three step holes in the inner torus of the second pole piece, i.e. the left step hole, the middle step hole, and the right step hole, in which N+1 of elastic rings and trapezoidal teeth are arranged closely within interval of the middle step hole, where N is a positive integer in 1 to 8. The teeth and rings are connected with the second pole piece via screws and shield rings. The N of trapezoidal teeth are arranged in the same expanding direction of their inner holes.

The first pole piece has the same structure with the second pole piece.

Among the parameters of the trapezoidal teeth, the height of the teeth is 2.5 mm, the width of the teeth is 0.5 mm, the tilt angle is 45°, the thickness of the elastic ring is 0.5 mm, and the difference of the inner and outer diameter is 2.52 mm.

The first bearing and the second bearing are linear bearing with the same type.

The beneficial effect of this invention is that the loss of ferrofluid through the carrying to the front end in the moving direction by the shaft is avoided by means of using elastic rings arranged in interval with the trapezoidal teeth in the pole pieces. Such that the leakage rate is less than 10⁻¹¹ pal·m³/s and the sealing life and pressure endurance capability are both increased.

### DESCRIPTION OF THE ACCOMPANYING DRAWINGS

FIG. 1 shows a ferrofluid sealing apparatus for a reciprocating shaft when N=3.

FIG. 2 shows the profile of the first and the second pole pieces.

FIG. 3 is the enlarged view of the part A in FIG. 2.

FIG. 4 shows the profile of the elastic rings.

FIG. 5 shows the profile of the trapezoidal teeth.

FIG. 6 shows the profile of the first and the second pole pieces when N=1.

FIG. 7 shows the profile of the first and the second pole pieces when there are 8 teeth.

FIG. 8 shows a ferrofluid sealing apparatus for a reciprocating shaft when N=8.

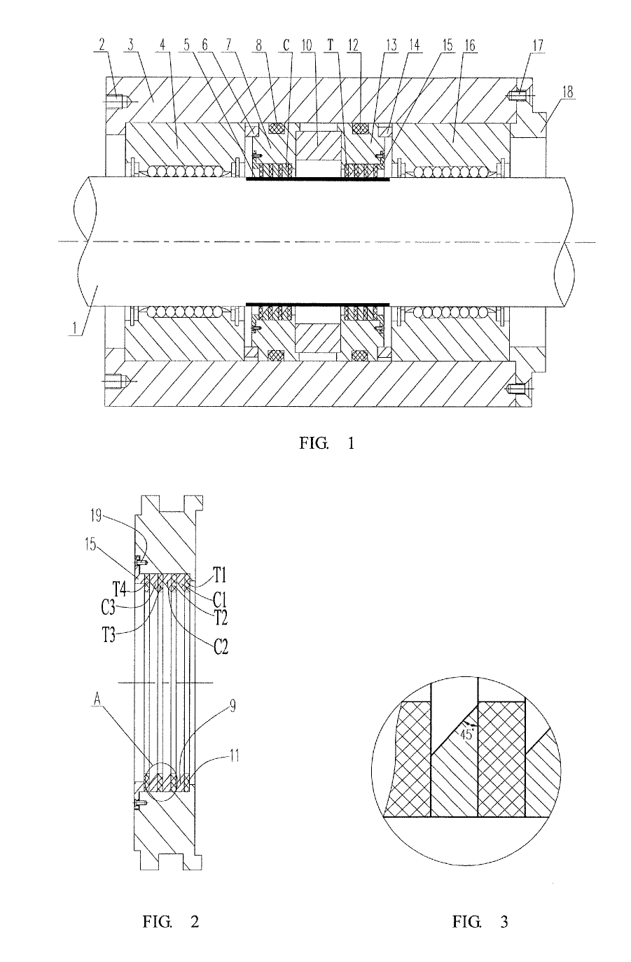

In the figures, there are shown a reciprocating shaft 1, thread holes 2, an outer casing 3, the first linear bearing 4, a polytetrafluoroethylene film 5, the first magnetism isolating ring 6, the first pole piece 7, the first O-shaped rubber seal 8, a trapezoidal teeth C, a magnet 10, an elastic ring T, the second O-shaped rubber seal 12, the second pole piece 13, the second magnetism isolating ring 14, a shield ring 15, the second linear bearing 16, screws 17, an end cover 18, and screws 19.

### PREFERRED EMBODIMENTS TO CARRY OUT THE PRESENT INVENTION

A further explanation of embodiments of this invention is made with the attached drawings.

### Mode 1

In the present invention, there is provided a ferrofluid sealing apparatus for a reciprocating shaft, in which the first bearing 4, the first magnetism isolating rings 6, the first pole piece 7, the first O-shaped rubber seal 8, the magnet 10, the second O-shaped rubber seal 12, the second pole piece 13, the second magnetism isolating ring 14, and the second bearing 16 are sandwiched between the two inner bosses of the outer casing 3 in series. The end cover 18 is fixed on the outer casing 3 by means of screws 17 so as to press the second bearing 16. The ferrofluid is injected into the inner torus of the magnet 10 during operation. The above sealing structure is installed to the reciprocating shaft 1 plated with polytetrafluoroethylene 5.

The first bearing 4 and the second bearing 16 are linear bearing with the same type.

The first pole piece 7 and the second pole piece 13 have the same structure. There are provided three step holes in the inner torus of the first pole piece 7, i.e. the left step hole, the middle step hole, and the right step hole.

The first elastic ring T1, the first trapezoidal teeth C1, and the second elastic ring T2 are arranged closely in interval in the middle step hole of the second pole piece 13, as in FIG. 3. The first elastic ring T1, the first trapezoidal teeth C1, and the second elastic ring T2 are fixed with the second pole piece 13 by means of screws and shield ring 15, as shown in FIG. 6.

### Mode 2

The difference with MODE 1 is that the first elastic ring T1, the first trapezoidal teeth C1, the second elastic ring T2, the second trapezoidal teeth C2, the third elastic ring T3, the third trapezoidal teeth C3, and the fourth elastic ring T4 are arranged closely in interval in the middle step hole of the second pole piece 13, as shown in FIG. 2.

### Mode 3

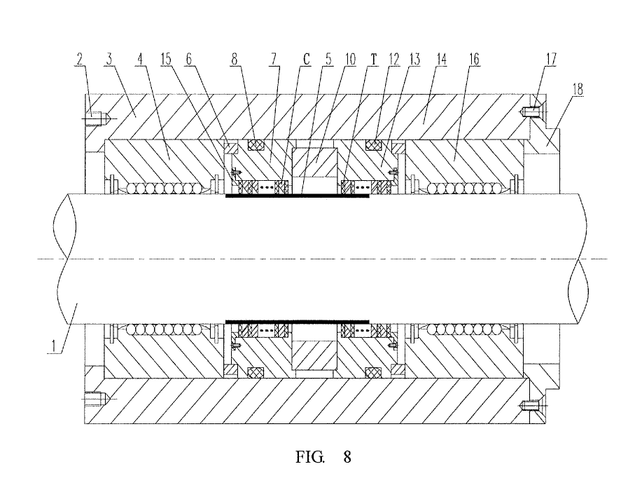

The difference with MODE 1 is that the first elastic ring T1, the first trapezoidal teeth C1, the second elastic ring T2, . . . , the seventh trapezoidal teeth C7, the eighth elastic ring T8, the eighth trapezoidal teeth C8, and the ninth elastic T9 are arranged closely in interval in the middle step hole of the second pole piece 13, as shown in FIG. 7 and FIG. 8.

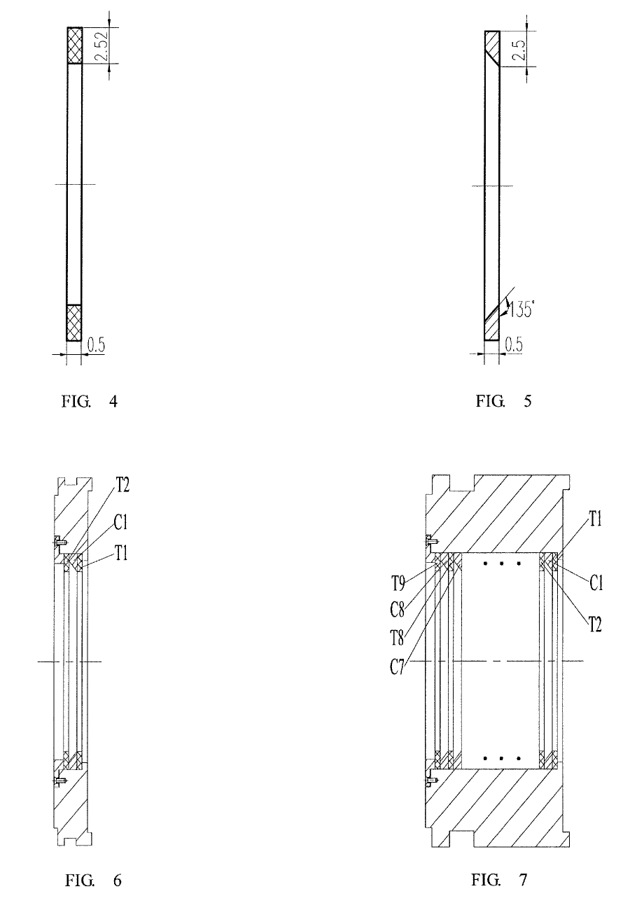

In MODEs 1 to 3, the parameters of the trapezoidal teeth C are that the height of the teeth is 2.5 mm, and the width of the teeth is 0.5 mm, the tilt angle is 45°, as shown if FIG. 5, the thickness of the elastic ring is 0.5 mm, and the difference of the inner and outer diameter is 2.52 mm, as shown in FIG. 4.

In MODEs 1 to 3, a groove whose depth is 0.1 mm and whose length is equal to 4×(the width of all the trapezoidal teeth+the width of all the elastic rings) is provided on the surface of the reciprocating shaft 1. The polytetrafluoroethylene film 5 with the depth 0.1 mm is plated in the groove. The polytetrafluoroethylene is of no bonding, so that it can decrease the loss of ferrofluid carried by the shaft when the shaft is reciprocating.

The screw thread holes 2 are designed in order to connect with other devices.

The outer casing 3, the first and the second magnetism isolating rings 6, 14, and the end cover 18 are made of non-magnetic materials, such as stainless steel etc.; the reciprocating shaft is made of a magnetic material like 45 steel. The material of the first and the second pole pieces 7, 13 and teeth 9 is electrical pure iron. The material of elastic rings 11 is nylon.

The first pole piece 7 and the second pole piece 13 have the same structure as each other. The grooves on the outer cylinder surface of the pole pieces are used to install the first and the second O-shaped rubber seals 8, 12. A counterbore is designed on one end face of the pole pieces, which is used to install the magnet. A boss is designed on the other end face of the pole pieces, which is used to install the magnetism isolating rings.

The bearing and the pole piece are separated from a distance by the magnetism isolating rings. The air gap between them increases the magnetic reluctance of the magnetic circuit, which can avoid the decrease of the magnetic field intensity in the sealing gap.

The permanent magnet 10 is made of Nd—Fe—B, Sm—Co, or Al—Ni—Co according to requirement of working temperature. The permanent magnet 10 is made of Nd—Fe—B if working in root temperature, is made of Sm—Co if working in the temperature above 300° C., or is made of Al—Ni—Co if working in the temperature above 400° C.

Kerosene, hydrocarbon, or diester based ferrofluid are used in common vacuum seal, fluorocarbon based ferrofluid is used in acid or alkali situation, and quality kerosene, silicate ester, or diester based ferrofluid are used when the temperature is very low.

Example: a ferrofluid seal for a reciprocating shaft has been designed. A groove whose depth was 0.1 mm was provided on the surface of the shaft between the two side faces of the bearings. The polytetrafluoroethylene film with the depth 0.1 mm was plated in the groove. The sealing stage was 6. The gap between the pole pieces and the shaft was 0.1 mm. The height of the teeth was 2.5 mm, the width of the teeth was 0.5 mm, the tilt angle was 45°, the thickness of the elastic ring was 0.5 mm. 15 mL ferrofluid based on kerosene was injected. The material of the permanent magnet was Nd—Fe—B. The pressure endurance capability of this apparatus was 0.8 atm and run 1080 h when the stroke was 200 mm and the speed was 200 rpm.

1. A ferrofluid sealing apparatus for a reciprocating shaft, in which the first bearing, the first magnetism isolating rings, the first pole piece, the first O-shaped rubber seal, a magnet, the second O-shaped rubber seal, the second pole piece, the second magnetism isolating ring, and the second bearing are sandwiched between the two inner bosses of the outer casing in series; an end cover is fixed on an outer casing by means of screws so as to press the second bearing; the ferrofluid is injected into the inner torus of the magnet during operation; the above sealing structure is installed on the reciprocating shaft plated with polytetrafluoroethylene,
characterized in that
there are provided with three step holes in the inner torus of the second pole piece (13) as left step hole, middle step hole, and right step hole, in which N+1 of elastic rings (T) and trapezoidal teeth (C) arranged closely within the interval of the middle step hole, where N is a positive integer in 1 to 8; the trapezoidal teeth (C) and the elastic rings (T) are connected with the second pole piece (13) by means of screws and shield rings (15); the N of the trapezoidal teeth (C) are arranged in the same expanding direction of their inner holes;
the first pole piece (7) is provided to have the same structure as the second pole piece (13).

2. A ferrofluid sealing apparatus for a reciprocating shaft according to claim 1, wherein among the parameters of the trapezoidal teeth, the height of the teeth is 2.5 mm, the width of the teeth is 0.5 mm, the tilt angle is 45°, the thickness of the elastic ring is 0.5 mm, and the difference of the inner and outer diameter is 2.52 mm.

3. A ferrofluid sealing apparatus for a reciprocating shaft according to claim 1, wherein the first bearing (4) and the second bearing (16) are linear bearing with the same type.
